(19) United States
(12) Patent Application Publication
(10) Pub. No.: US 2005/0108385 A1
(43) Pub. Date: May 19, 2005

(54) Method and system for managing a discovery-related process in a network

(76) Inventors: Gabriel Wechter, Fort Collins, CO (US); Eric Pulsipher, Fort Collins, CO (US); Max C. Knees, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/693,965

(22) Filed: Oct. 28, 2003

(51) Int. Cl. G06F 15/173

(52) U.S. Cl. 709/224

(57) ABSTRACT

An exemplary method for managing a discovery-related process in a network, includes identifying topology information of the network using the discovery-related process in an active mode, placing the discovery-related process from the active mode into a standby mode using a management process, monitoring to detect specified events in the network using the management process and then forward the detected specified events to the discovery-related process, and/or monitoring to detect arrival of a predetermined point in time, and placing the discovery-related process from the standby mode into the active mode when the detected specified events exceed a threshold and/or when the predetermined point in time arrives.

### BACKGROUND

Known solutions for discovering networks leave all processes active and running, even when these processes are idle because their work is done, and when the work is unlikely to be redone in the near future. This can result in wasted computer system resources and degraded system performance, by bloating the set of running processes and not reclaiming unused resources of the computer system that the active processes hold. In these solutions, an administrator who desires to shut down idle processes would have to monitor for completion of the process tasks and then shut down the processes by hand.

### SUMMARY

An exemplary method for managing a discovery-related process in a network, includes identifying topology information of the network using the discovery-related process in an active mode, placing the discovery-related process from the active mode into a standby mode using a management process, monitoring to detect specified events in the network using the management process and then forward the detected specified events to the discovery-related process, and/or monitoring to detect arrival of a predetermined point in time, and placing the discovery-related process from the standby mode into the active mode when the detected specified events exceed a threshold and/or when the predetermined point in time arrives. A machine readable medium can include software or a computer program or programs for causing a computing device to perform the exemplary method.

An exemplary system for managing a discovery-related process in a network, includes a mechanism or means for identifying topology information of the network in an active mode, and a mechanism or means for placing the discovery-related process from the active mode into a standby mode, for detecting specified events in the network and forwarding the detected specified events to the means for identifying, and/or for detecting arrival of a predetermined point in time, wherein the means for identifying compares the detected specified events against a threshold and shifts from the standby mode into the active mode when the detected specified events exceed the threshold, and/or shifts from the standby mode into the active mode when arrival of the predetermined point time is detected.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates a functional diagram in accordance with an exemplary method.

FIG. 2 illustrates a system diagram in accordance with an exemplary embodiment.

FIG. 3 illustrates a functional diagram in accordance with an exemplary embodiment or method.

### DETAILED DESCRIPTION

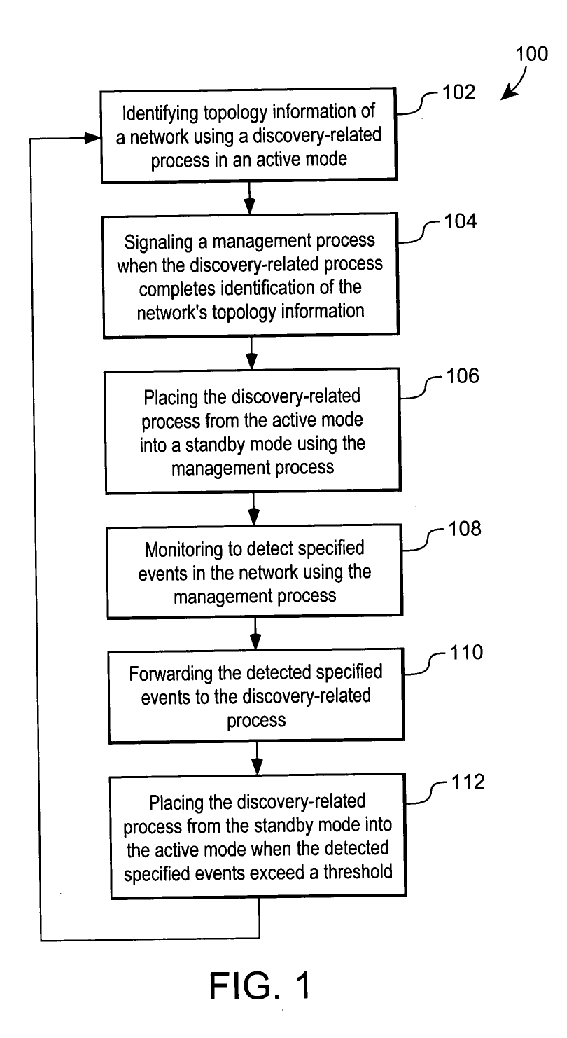

FIG. 1 illustrates functional diagram in accordance with an exemplary method. As shown in FIG. 1, an exemplary method 100 for managing a discovery-related process in a network includes in block 102, identifying topology information of the network using the discovery-related process in an active mode. From block 102 control proceeds to block 104, which includes signaling the management process when the discovery-related process completes identification of the network's topology information. From block 104, control proceeds to block 106, which includes placing the discovery-related process from the active mode into a standby mode using a management process. From block 106, control proceeds to block 108, which includes monitoring to detect specified events in the network using the management process. From block 108, control proceeds to block 110, which includes forwarding the detected specified events to the discovery-related process. From block 110, control proceeds to block 112, which includes placing the discovery-related process from the standby mode into the active mode when the detected specified events exceed a threshold. From block 112, control can return to block 102 so that the process can repeat.

In exemplary embodiments of the method, the following features can also be variously implemented. The discovery-related process can transit from the active mode to the standby mode in an ordered sequence. The discovery-related process can identify the network's topology information in response to the discovery-related process transiting from the standby mode to the active mode. The discovery-related process of performing identification of the network's topology information in response to the discovery-related process transiting from the standby mode to the active mode, can include subprocesses such as a) restarting initial subprocesses of the discovery-related process and b) providing network topology information discovered by the initial subprocesses to inactive subprocesses of the discovery-related process, where the inactive subprocesses become active in response to the provided network topology information. The initial subprocesses can be restarted in an ordered sequence. After the discovery-related process identifies the network's topology information in response to the discovery-related process transiting from the standby mode to the active mode, the discovery-related process can be placed from the active mode into the standby mode using the management process to repeat the overall cycle. When in standby mode, the discovery-related process can compare the detected specified events to the threshold, and then initiate a transition from the standby mode to the active mode when the detected specified events exceed the threshold and/or when a specified time for rediscovery arrives.

Exemplary specified events that can be detected and compared to the threshold can include, for example, such network events as:
new node being added to the network;
a node being deleted from the network topology;
addition of a new interface to the network;
deletion of an interface from the network;
a change in status of a node or interface (e.g., from active to inactive);
a change of a node name;
a node becoming managed/un-managed;
a change in a node's Object ID;
a change in a node's connector properties;
a change in a node's gateway properties;
a node changing to, or being found to support SNMP;
a change in a node's forwarding table;
changes in a node's SNMP address;
changes in SNMP community strings used to access nodes;
finding a new network or subnet;
deletion of a network or subnet from the topology; and
new or changed connections between devices in the network.

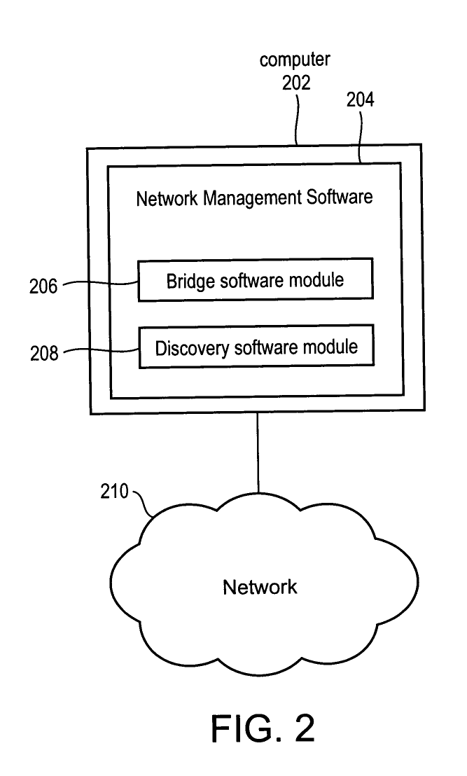

FIG. 2 illustrates an exemplary system for managing a discovery-related process in a network, that is capable of performing the methods described herein. In particular, FIG. 2 shows means for identifying topology information of the network in an active mode, for example the discovery software module 208. Also shown are means for placing the discovery-related process from the active mode into a standby mode and for detecting or monitoring to detect specified events in the network and forwarding the detected specified events to the means for identifying, for example the bridge or management software module 206. The module 206 can also detect arrival of a predetermined point in time. The module 208 can also compare the detected specified events against a threshold and shift from the standby mode into the active mode when the detected specified events exceed the threshold, and/or shift from the standby mode into the active mode when arrival of the predetermined point time is detected. Also shown is network management software 204, encompassing the software modules 206, 208 and running on a computer 202. The software 204 and modules 206, 208 can be stored in memory of the computer 202 for execution by one or more processors of the computer 202. As shown in FIG. 2, the computer 202 is connected to a network 210 that can be discovered by the network management software 204, in particular by the discovery software module 208.

In an exemplary embodiment, the discovery-related process associated with performing the discovery of a network is able to send a message to the management process, to indicate that the discovery-related process has completed its work of processing the batch of data, or in other words has finished discovering the network while in an active mode by identifying topology information of the network. The management process receives this message, and sends shutdown messages to various processes or subprocesses associated with the discovery, including processes within and without the discovery-related process, that are deemed to be no longer needed since their work is complete (at least, for example, until the next network discovery).

The management process proceeds with shutting down unneeded processes in an orderly fashion that respects any dependencies among the processes involved. The management process also reclaims system resources used by the discovery-related process, by restarting the discovery-related process and placing it into a standby-mode, where it can self-monitor for the need to process a fresh batch of data (or rediscover of the network). This can be performed, for example, by the management process detecting specified network events and reporting or forwarding them to the discovery-related process, which compares the detected events against one or more thresholds and when a threshold is exceeded, initiates a transition from the standby mode to the active mode by sending a message to the management process requesting the management process to awaken the processes needed for discovering the network. A single threshold can be used, for comparison with a number of specified network events (of all kinds) that have occurred. More than one threshold can be used, for example a threshold can be used for each type of network event, and/or for example thresholds corresponding to groups of different types of network events can be used to indicate when rediscovery should be performed.

A time threshold or timer/clock can also be used, so that when a time period expires, for example a time period since the end or beginning of the last network discovery, or when a predetermined point in time arrives, the discovery-related process initiates a transition from the standby mode to the active mode. The discovery-related process can include a timing mechanism for tracking this time period or point in time, or can receive a signal from a timing mechanism that indicates expiration of the time period or arrival of the point in time. The predetermined point in time can for example coincide with or correspond to the end or expiration of a time period, or can relate to the actual, probable or scheduled occurrence of an event that would require or recommend rediscovery, or can simply relate to a point in time at which the user or administrator desires rediscovery to occur or commence.

When the management process receives a request from the discovery-related process to awaken the processes necessary or desirable for discovery, it restarts the processes in a manner and sequence that respects any dependencies they may have on each other. In an exemplary embodiment, the awakening of certain of the processes associated with network discovery of the active mode of the discovery-related process by the management process, for example “finders”, causes the finders to initialize in such a way that they introduce seed data needed to begin the new network discovery into a data flow sampled by others of the processes relating to discovery.

This seed data can awaken or trigger others of the discovery processes (for example, discovery processes or subprocesses comprising the discovery-related process having overall responsibility for discovering the network) to begin processing and/or obtaining data, i.e. discovering the network. The seed data obtained by the finders and injected or introduced into the data flow can be initially determined and then stored or written by the management process, and can be made available to the finders. The management process can update the stored seed data upon receiving the request from the discovery-related process to awaken the processes necessary or desirable for discovery.

In an exemplary embodiment, the management process can communicate with a mechanism that tracks process or subprocess status, for example a status tracking module. An indication of process or subprocess status enables the management process to differentiate between a) a case where processes associated with network discovery were automatically shutdown (e.g., upon command by the management process) and are awaiting automatic restart (e.g., through actions initiated by the discovery-related process and/or the management process), and b) cases where the processes or subprocesses were shut down by some other means or mechanism. A human system administrator can also request and observe process status provided by the status tracking module.

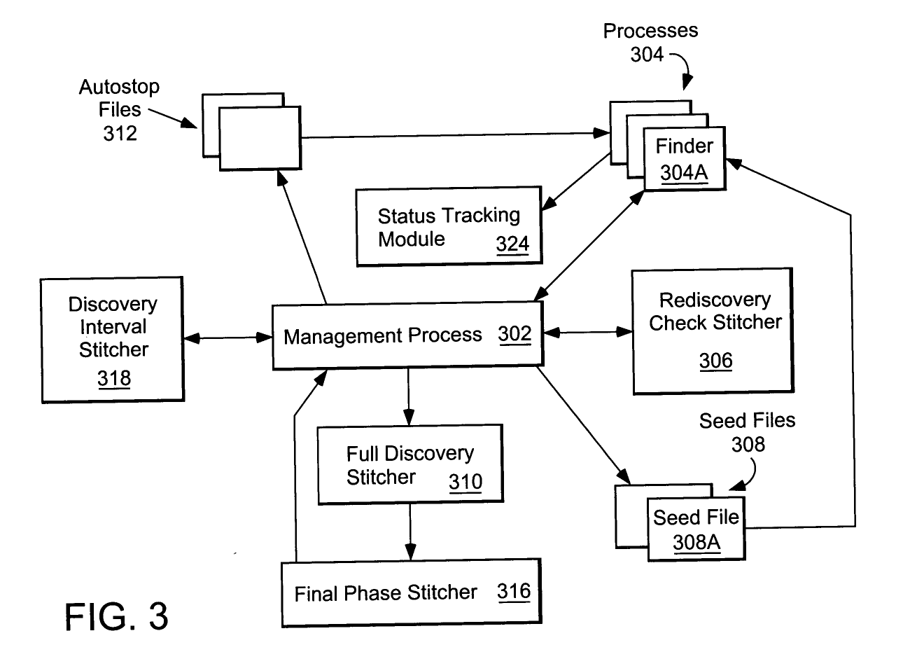

FIG. 3 shows exemplary processes and subprocesses and interactions among them, consistent with the exemplary methods and embodiments described herein. In particular FIG. 3 shows a manager or management process 302, a status tracking module 324, seed files 308 including a seed file 308A, processes or subprocesses 304 including a finder 304A, autostop files or data 312, and discovery subprocesses that can be part of the discovery-related process. The discovery subprocesses include a final phase stitcher 316, a discovery interval stitcher 318, a rediscovery check stitcher 306, and a full discovery stitcher 310. A stitcher is an entity that can receive and convey information, and also reformat or process the information.

As shown in FIG. 3, the manager or management process 302 can receive requests to awaken discovery processes and dump information, for example update the seed files 308, 308A, from either the discovery interval stitcher 318 or the rediscovery check stitcher 306. The discovery interval stitcher 318 can track a time interval and send the request to awaken when the time interval expires. The time interval can be periodic, can be a specific time, and can be a default value and/or can be specified by a user. The rediscovery check stitcher 306 can compare detected, specified network events (e.g., detected by the management process and reported to the discovery-related process, for example the rediscovery check stitcher 306) against one or more thresholds, and can send the request to awaken to the management process 302 when one or more thresholds are exceeded or met. After receiving such a request to awaken discovery processes and dump information to seed files or update the seed files 308, 308A, the management process 302 dumps information to and/or updates the seed files 308, 308A, and signals the processes 304 including the finder 304A to awaken, so the processes can access the data in the seed files and can perform their functions. The management process 302 then signals the full discovery stitcher 310 that full discovery may commence. After receiving the signal that full discovery may commence, the full discovery stitcher 310 embarks on a new network discovery. For final phases of the network discovery, control proceeds from the full discovery stitcher 310 to the final phase stitcher 316, and when the final phase stitcher 316 completes all remaining discovery-related tasks it signals the management process 302 that discovery is complete, and unneeded processes can be shut down. The management process 302 sets autostop files or flags 312 to allow the processes 304, 304A to discern that the processes relating to discovery are shutdown or are being shutdown, and then signals the processes 304 including the finder 304A to shutdown. The processes 304 can also check the autostop files or flags to determine if the management process 302 has relayed a request for, or is proceeding with, a shutdown. After the management process 302 has signaled the processes 304 to shutdown, it removes the autostop file or flag. When the processes or subprocesses 304, 304A are shut down or are being shut down, they can signal the status tracking module 324 to indicate why they were shut down or which entity or process commanded them to shut down, and in an exemplary embodiment can periodically send status signals to the status tracking module 324.

Below is pseudocode consistent with the exemplary embodiments and methods described above, that can be used to implement the methods shown in FIGS. 1 and 3 and the methods described above as well as the software 204 and modules 206, 208 shown in FIG. 2.

In Manager (e.g., the Management Process 302):

The following occurs in a thread of the MANAGER process that loops listening for signals sent to MANAGER over a bus from other processes:

```
if (an incoming signal is detected) {
    if (the signal is the DISCO_DONE (discovery complete) signal sent from
    DISCO (the discovery-related process) upon its
    completion of discovery) {
        Create (and open and close) the .autostop file, the
        existence of which indicates to any processes who are shutting down that
        the outstanding shutdown request originated from this auto-management
        mechanism.
        Restart the DISCO (discovery-related) process, in stand-by mode:
            First stop any process(es) that DISCO has a dependency on
            (e.g., meaning DISCO cannot run if that process is not running).
            Stop DISCO, and reclaim memory resources allocated to it.
        Leave a select set of crucial processes always running:
            Wait until processes (e.g., processes 304, 304A) report being
            stopped.
            Restart the process(es) that DISCO is dependent upon.
            Restart DISCO in stand-by mode, doing minimal processing
            and using minimal resources.
            Stop any processes that are no longer needed to be running (including
            any agents for discovering information about network devices, finders
            for finding network devices, SNMP (Simple Network Management
            Protocol) and DNS (Domain Name Server) agents.
            Remove the .autostop file(s) (e.g., the files 312), since the automatic
            stopping has completed and resulted in process status updates
            indicating this state.
            Clear the incoming signal (DISCO_DONE) from the queue,
            since we have handled it.
    } else if (the signal is the DO_NEW_DISCO signal sent from DISCO (e.g.,
    the rediscovery check stitcher 306) upon detection of the need to rediscover
    due to exceeding a threshold) {
      Reawaken what is needed (e.g., the processes 304, 304A) ... it's
      showtime:
            Export select network information gathered up to this point
            (including that needed to seed the upcoming discovery via a
            “FINDER” process, e.g. update the seed files 308, 308A).
            Clear the incoming signal (DO_NEW_DISCO) from the queue.
            Set a flag file to indicate to the FINDER (e.g., the finder 304A) that
            MANAGER is requesting it to perform a discovery, hence allowing its
            seed information to be injected into the discovery process in order to
            start a discovery.
            Restart all the other processes related to discovery, kicking off the
            initialization of processes which will detect the state of being time for
            discovery to be performed.
    } end if
} end if
Also done by MANAGER in another thread:
    Upon startup, look for a file that contains the last count of network
    change events. Initialize the change (delta) counter to this value.
    Detect any changes in the network that have occurred to the latest stored
    topology. Increment the change counter for these events.
    Every minute, send a signal to the DISCO process to update a database
    with the latest delta value.
    if (MANAGER detects the signal that a new discovery is to begin) {
        clear the change counter
    } end if
```

In Disco:

Upon Startup:

```
    Report status as showing the last time a
    discovery completed, as indicated in
    a persistent file that was written just before
    the last time DISCO signaled that
    it completed discovery.
    Check to see if FINDER (e.g., the finder 304A)
    has passed any new info on to DISCO.
    If (DISCO was passed data) {
        Start a network discovery based
        upon the passed seed data.
        Upon completion of discovery and
        output of topology data to database,
        save a timestamp of the discovery completion
        time and status, and send a
        signal to MANAGER that discovery has completed.
    } else {
        Remain in stand-by mode, monitoring
        for the need to discover (see below).
    } end if
Every minute, check the latest change count
(sent from MANAGER) against the
configured threshold:
    if ((number of network change events >
    threshold) or (it is the configured
    scheduled time for a new discovery (e.g., as
    tracked by the discovery interval
    stitcher 318)) {
        Check if a discovery is in progress (using
        a state variable in a database).
            if (Discovery is NOT in progress) {
                Send a signal to MANAGER that
                a new discovery is needed.
            } end if
    } end if
```

In Finder:

```
Upon startup, check to see if a state flag was
set (by MANAGER) indicating
that a discovery should take place:
    If (a discovery should take place) {
        Read a file produced by MANAGER that
        provides data indicating known
        network devices to seed discovery.
        Send the seed data to DISCO (via
        database inserts), hence
        effectively beginning the new discovery.
        Clear the state flag that was set (by
        MANAGER), since the discovery
        has been initiated.
    } end if
```

In code shared by all processes (e.g., the status tracking module 324) to track their status:

```
If (the process receives the signal to shut down) {
    Check to see why (under what circumstances) that signal was sent.
    If (the .autostop file is present) {
        Report the process status as being stopped but in a state
        in which it is awaiting a signal to be automatically
        restarted when it is
        time for a new discovery.
    } else {
        The stop signal was issued for some other reason (e.g., by
        the user).
        Report status that the processes has simply been stopped.
    } end if
} end if
```

The methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth).

Those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. Method for managing a discovery-related process in a network, comprising:
identifying topology information of the network using the discovery-related process in an active mode;
placing the discovery-related process from the active mode into a standby mode using a management process;
monitoring to detect specified events in the network using the management process and then forward the detected specified events to the discovery-related process, and/or monitoring to detect arrival of a predetermined point in time; and
placing the discovery-related process from the standby mode into the active mode when the detected specified events exceed a threshold and/or when the predetermined point in time arrives.

2. The method of claim 1, comprising:
signaling the management process when the discovery-related process completes identification of the network's topology information.

3. The method of claim 1, wherein the discovery-related process transits from the active mode to the standby mode in an ordered sequence.

4. The method of claim 1, comprising:
the discovery-related process identifying the network's topology information in response to the discovery-related process transiting from the standby mode to the active mode.

5. The method of claim 4, wherein the discovery-related process performing identification of the network's topology information in response to the discovery-related process transiting from the standby mode to the active mode comprises:
restarting initial subprocesses of the discovery-related process;
providing network topology information discovered by the initial subprocesses to inactive subprocesses of the discovery-related process; and
the inactive subprocesses becoming active in response to the provided network topology information.

6. The method of claim 5, wherein the initial subprocesses are restarted in an ordered sequence.

7. The method of claim 4, comprising:
repeating the placing the discovery-related process from the active mode into the standby mode using the management process, after the discovery-related process identifies the network's topology information in response to the discovery-related process transiting from the standby mode to the active mode.

8. The method of claim 1, wherein the discovery-related process in the standby mode compares the detected specified events to the threshold, and initiates a transition from the standby mode to the active mode when the detected specified events exceed the threshold.

9. A system for managing a discovery-related process in a network, comprising:
means for identifying topology information of the network in an active mode;
means for placing the discovery-related process from the active mode into a standby mode, for detecting specified events in the network and forwarding the detected specified events to the means for identifying, and/or for detecting arrival of a predetermined point in time;
wherein the means for identifying compares the detected specified events against a threshold and shifts from the standby mode into the active mode when the detected specified events exceed the threshold, and/or shifts from the standby mode into the active mode when arrival of the predetermined point time is detected.

10. The system of claim 9, wherein the means for identifying signals the means for placing, detecting and forwarding when the means for identifying completes identification of the network's topology information.

11. The system of claim 9, wherein the means for identifying shifts from the active mode to the standby mode in an ordered sequence.

12. The system of claim 9, wherein the means for identifying identifies the network's topology information in response to shifting from the standby mode to the active mode.

13. The system of claim 9, wherein the means for identifying in the standby mode compares the detected specified events to the threshold, and initiates a shift from the standby mode to the active mode when the detected specified events exceed the threshold.

14. The system of claim 13, wherein the means for placing, detecting and forwarding shifts the means for identifying into the standby mode and the means for identifying initiates a shift into the active mode when the detected specified events exceed the threshold, in a repeating cycle.

15. A machine readable medium comprising a computer program for causing a computer to perform:
identifying topology information of the network using the discovery-related process in an active mode;
placing the discovery-related process from the active mode into a standby mode using a management process;
monitoring to detect specified events in the network using the management process and then forward the detected specified events to the discovery-related process, and/or monitoring to detect arrival of a predetermined point in time; and
placing the discovery-related process from the standby mode into the active mode when the detected specified events exceed a threshold and/or when the predetermined point in time arrives.

16. The medium of claim 15, comprising a computer program for causing a computer to perform:
signaling the management process when the discovery-related process completes identification of the network's topology information.

17. The medium of claim 15, wherein the discovery-related process transits from the active mode to the standby mode in an ordered sequence.

18. The medium of claim 15, comprising a computer program for causing a computer to perform:
the discovery-related process identifying the network's topology information in response to the discovery-related process transiting from the standby mode to the active mode.

19. The medium of claim 18, wherein the discovery-related process performing identification of the network's topology information in response to the discovery-related process transiting from the standby mode to the active mode comprises:
restarting initial subprocesses of the discovery-related process;
providing network topology information discovered by the initial subprocesses to inactive subprocesses of the discovery-related process; and
the inactive subprocesses becoming active in response to the provided network topology information.

20. The medium of claim 19, wherein the initial subprocesses are restarted in an ordered sequence.

21. The medium of claim 18, comprising a computer program for causing a computer to perform:
repeating the placing the discovery-related process from the active mode into the standby mode using the management process, after the discovery-related process identifies the network's topology information in response to the discovery-related process transiting from the standby mode to the active mode.

22. The medium of claim 15, wherein the discovery-related process in the standby mode compares the detected specified events to the threshold, and initiates a transition from the standby mode to the active mode when the detected specified events exceed the threshold.
